(19) United States
(12) Patent Application Publication
(10) Pub. No.: US 2004/0056888 A1
(43) Pub. Date: Mar. 25, 2004

(54) Network address display device and network address allocation device

(76) Inventor: Kentaro Fujinuma, Tokyo (JP)

Correspondence Address: BIRCH STEWART KOLASCH & BIRCH, PO BOX 747, FALLS CHURCH, VA, 22040-0747, US

(21) Appl. No.: 10/433,898

(22) PCT Filed: Dec. 20, 2001
(86) PCT No.: PCT/JP01/11173

(30) Foreign Application Priority Data
Dec. 25, 2000 (JP) 2000-392233

(51) Int. Cl. G06F 15/173; G09G 5/00

(52) U.S. Cl. 345/736; 709/223

(57) ABSTRACT

A display section divides a network address into an upper part of address 57 and a lower part of address 59, and displays a two-dimensional graph 53 in use of the upper part of address 57 and the lower part of address 59 for each coordinate axis on a display screen 31. In the two-dimensional graph 53, a display section displays, distinctively, an allocated area 43 in which the network address has been already allocated and an unallocated area 41 in which the network address has not been allocated. An allocation section allocates the network address by selecting the unallocated area 41 displayed on the two-dimensional graph 53 from a display screen 31 and changes the unallocated network address area 41 selected to the allocated network address area 43 so as to display.

### TECHNICAL FIELD

The invention relates to a display device for displaying network addresses and an allocation device for allocating network addresses. Uniquely, the invention relates to a device for allocating network addresses by displaying the network address on a display screen as a two-dimensional area.

### BACKGROUND ART

FIG. 10, for instance, shows a display screen displaying network addresses by a conventional technique such as the Japanese unexamined publication No. 8-139757. The screen of the display device shows contents of routing tables, included in each of remote routers 4-1 through 4-n as shown on FIG. 10. If there is an error in the contents of the routing tables, “*” is put at the error. The error should be informed an appropriate personnel who manages the remote router by the network manager, and the contents of the routing table in the remote router should be corrected.

The network address is an array of numbers as shown on FIG. 10. Even if the network addresses are displayed as a list as shown on FIG. 10, it is difficult to distinguish between the allocated and the unallocated among the addresses. Also, FIG. 10 shows a case in which data are collected from the remote routers and there assumes to contain an error. Each of the network addresses is set by the remote routers respectively so that an error occurs in allocating the network addresses among the remote routers.

The objective of the invention is to provide a network address display device which can easily distinguish between an allocated address and an unallocated one.

Further, the objective of the invention is to provide a network address allocation device which can allocate a network address without any error and inconsistency.

### DISCLOSURE OF THE INVENTION

A network address display device of the invention is featured by dividing a network address into an upper part of address and a lower part of address, displaying a two-dimensional graph in use of the upper part of address and the lower part of one for each coordinate axis, and displaying an allocated network address area and an unallocated network address area distinctively on the two-dimensional graph.

A network address allocation device of the invention is featured by including:

a display section for dividing a network address into an upper part of address and a lower part of address, displaying a two-dimensional graph in use of the upper part of address and the lower part of address for each coordinate axis on a display screen, and displaying an allocated network address area and an unallocated network address area distinctively on the two-dimensional graph; and

an allocation section for allocating the network address by selecting the unallocated network address area displayed on the two-dimensional graph from the display screen and changing the unallocated network address area selected to an allocated network address area so as to display.

The above allocation section is featured by, in case of allocating the network address, prohibiting to select the allocated network address area again.

The above allocation section is featured by dividing 2⁸ numbers of the allocated network addresses per an area of 2⁰, 2¹, 2², 2³, 2⁴, 2⁵, 2⁶, and 2⁷, and selecting each of divided areas as a unit for selection.

The above display section is featured by displaying, distinctively, an allocatable network address area allowed to be allocated by the allocation section and an unallocatable network address area not allowed to be allocated.

### BRIEF DESCRIPTION OF THE FIGURES

FIG. 1 shows a system configuration of the first embodiment.

FIG. 2 shows an example of a display screen 31.

FIG. 3 shows an operational flow chart of a display section 101 and an allocation section 103.

FIG. 4 shows an example of a two-dimensional diagram 53.

FIG. 5 shows an example of an IP address allocation list.

FIG. 6 shows an operation of NEW ALLOCATION.

FIG. 7 shows an operation of ENLARGE.

FIG. 8 shows another example of the display screen 31.

FIG. 9 shows an example of the display screen 31 which is shown to a network manager of lower position.

FIG. 10 shows an example of a display screen displaying network addresses by a conventional technique.

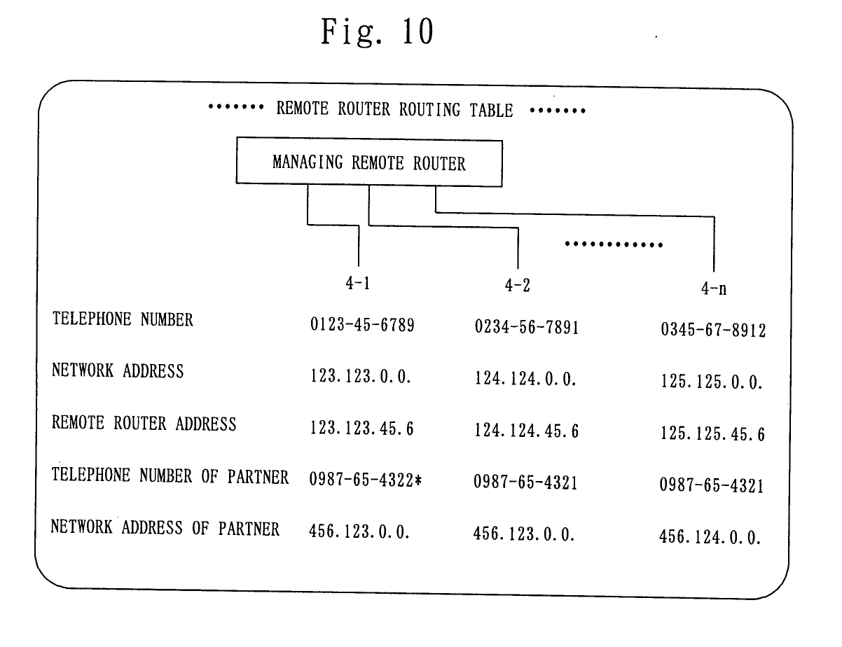

### BEST MODE FOR CARRYING OUT THE INVENTION

Embodiment 1.

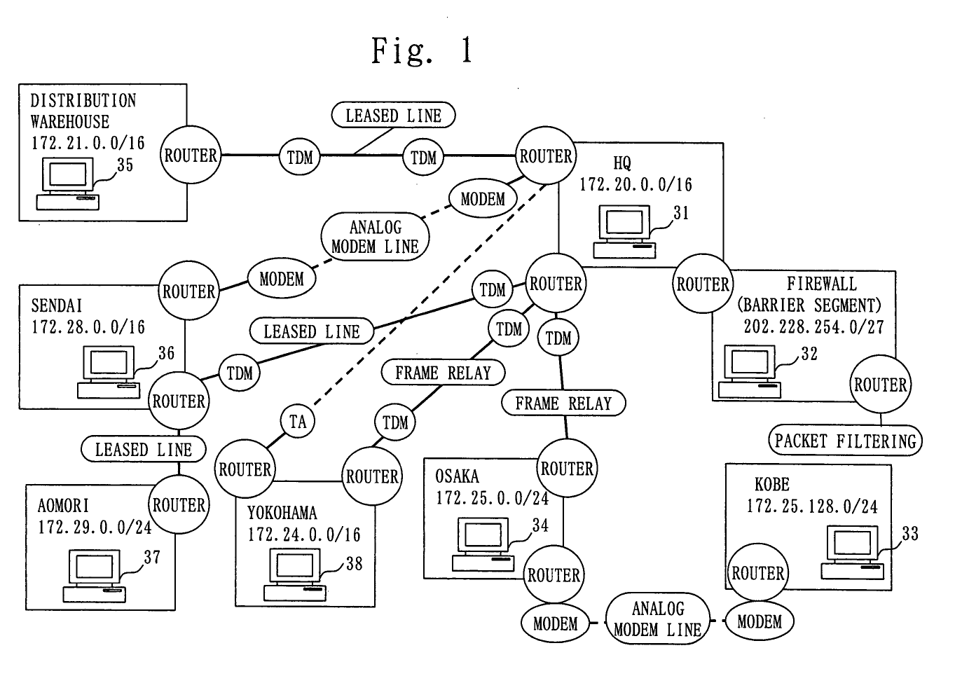

FIG. 1 shows a network system configuration between HQ (Headquarters) and local branches.

A router is provided at HQ and each of the branches. Each router is connected to the network, using TDM (Time-Divisional Multiple access) method, a modem, or a terminal adapter. Of course, the router can be connected using another interface or protocol, which is not described here. A local area network is provided at HQ and each of the branches. This local area network is shown as a square in FIG. 1. This local area network, for example, can be configured using Ethernet. Network addresses are allocated to all computers and various devices, which connect each local area network of HQ and each of the branches. The network address consists of addresses with four bytes, which can specify hierarchical addresses from upper byte to lower byte. For example, FIG. 1 shows a case in which when the first byte is 172, the address covers all the system of HQ and the branches. When the second byte is 20, the address shows the system of HQ. When the second byte is 21, the address shows the system of a distribution warehouse. When the second byte is 28, the address shows the system of Sendai branch. In this way, at HQ, the distribution warehouse, Sendai branch, and Yokohama branch, the same upper 2 bytes (upper 16 bits) are used for those network addresses. Also, the network addresses are allocated to Aomori branch, Osaka branch, and Kobe branch in use of the upper 3 bytes (namely, upper 24 bits).

A network address is given to a firewall, shown on FIG. 1, in use of upper 27 bits.

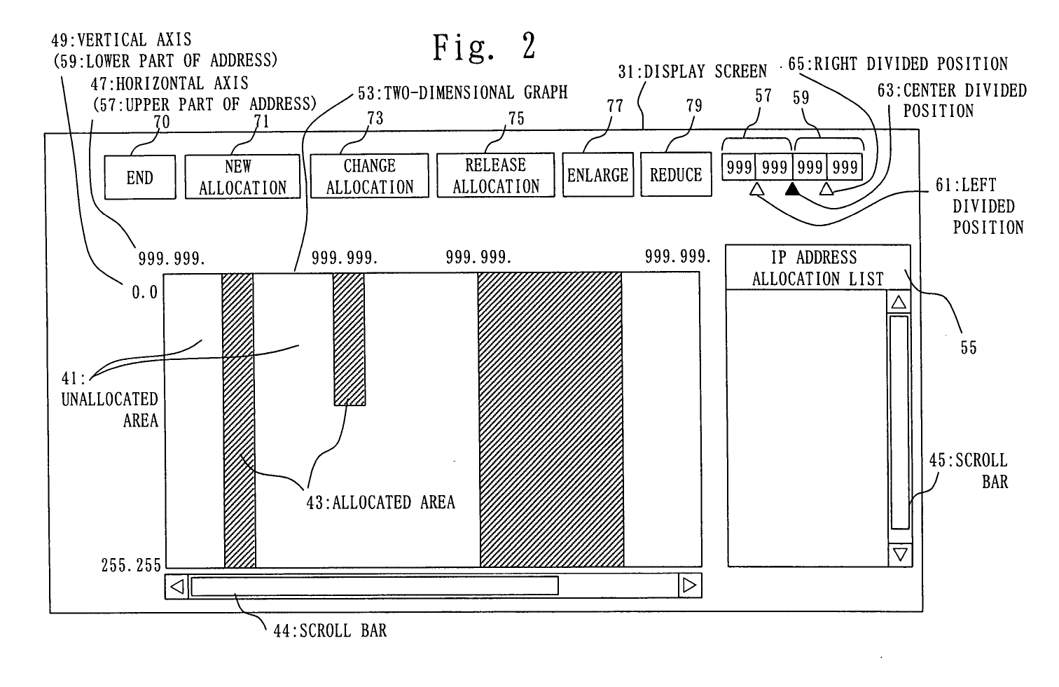

FIG. 2 shows a display screen 31 displayed on the display device of the computers for the network managers of HQ and each of the branches.

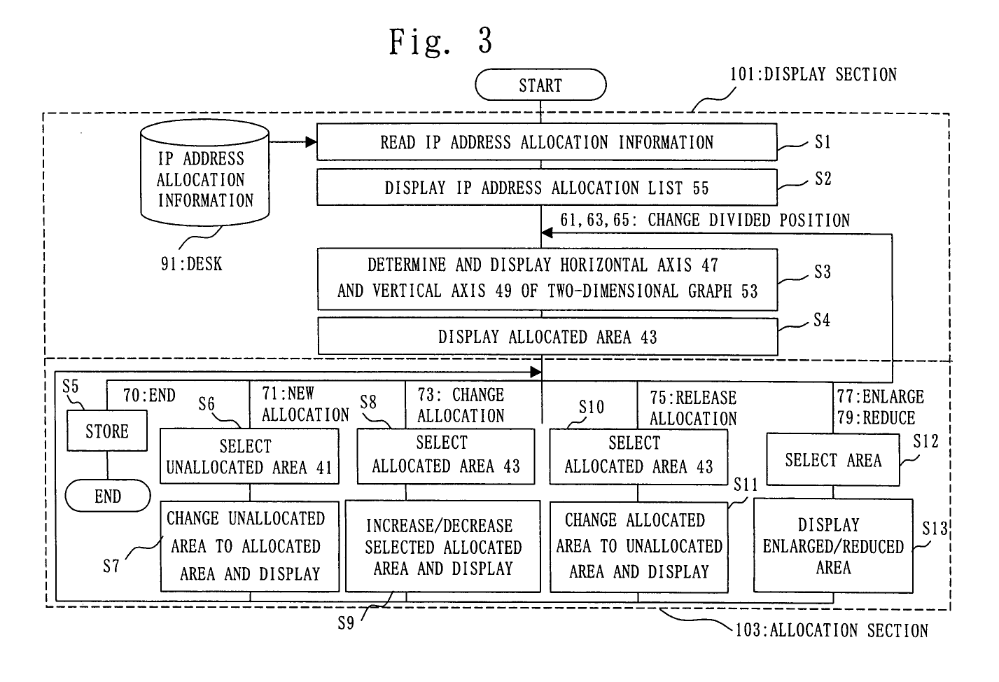

FIG. 3 shows an operational flowchart of a display section 101 and an allocation section 103, using the display screen 31 shown in FIG. 2. The display section 101 and the allocation section 103 can be implemented as computer program, and executed by Central Processing Unit (CPU), through loading into Random Access Memory from a magnetic disk drive, an optical disk drive, or a flexible disk drive of the computer. Also, the display section 101 and the allocation section 103 are not restricted as computer program form, and at least a part of or all of the display section 101 and the allocation section 103 can be implemented as a hardware or a firmware.

Each of display component shown on FIG. 2 will be explained hereinafter.

Various buttons are provided at the upper part of the display screen 31. An END button 70 is to close the display screen 31. A NEW ALLOCATION button 71 is to allocate a new network address. A CHANGE ALLOCATION button 73 is to change an allocated network address. A RELEASE ALLOCATION button 75 is to change the allocated network address to the unallocated one. An ENLARGE button 77 is to enlarge a size of the display portion. A REDUCE button 79 is to reduce a size of the display portion. A left divided position 61, a center divided position 63, and a right divided position 65 are buttons are to indicate a place to divide the network address. In case of FIG. 2, the buttons indicate to divide the network address between the second byte and the third byte. Accordingly, the first and the second bytes become an upper part of address 57. Also, the third and the fourth bytes become a lower part of address 59. A two-dimensional graph 53 shows the upper part of address 57 as a horizontal axis 47 and the lower part of address 59 as a vertical axis 49. In this way, by placing the upper part of address 57 and the lower part of address 59 in the two-dimensional matrix form, the network address can be expressed a zone with an area. The allocated network address is displayed on an allocated area 43 as highlighted. And an area of the unallocated network is displayed normally as an unallocated area 41. If all the network addresses cannot be displayed on the two-dimensional graph 53, a scroll bar 44 is used to shift the display screen to left/right to display all information. Although it is not illustrated in FIG. 2, the information can be displayed in scroll by shifting a scroll bar 45 upward/downward. An IP address allocation list 55 is an area for displaying the allocated area 43 shown in the two-dimensional graph 53 in text form. If the information to be displayed in the IP address allocation list 55 in text form is much, the information can be displayed by scrolling upward/downward in use of the scroll bar 45. Further, it is also possible to move the scroll bar 45 to left/right, which is not illustrated.

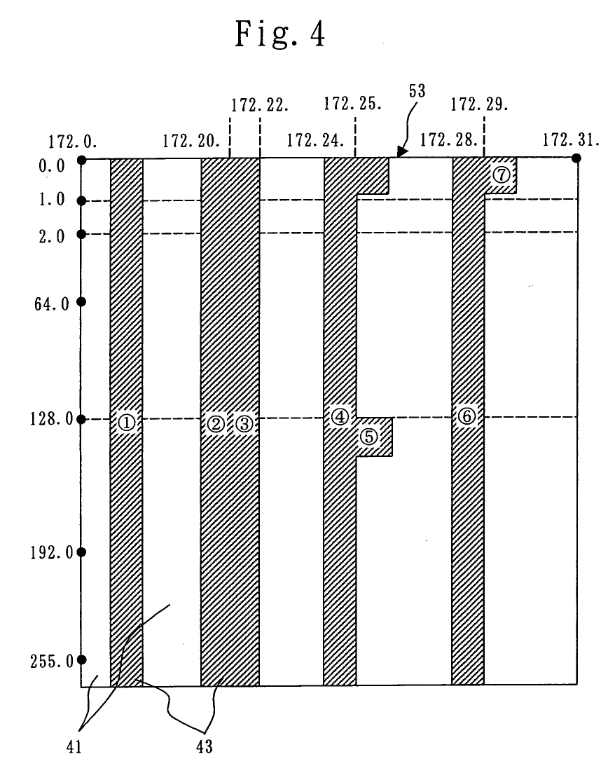

FIG. 4 shows a concrete example of the two-dimensional graph 53.

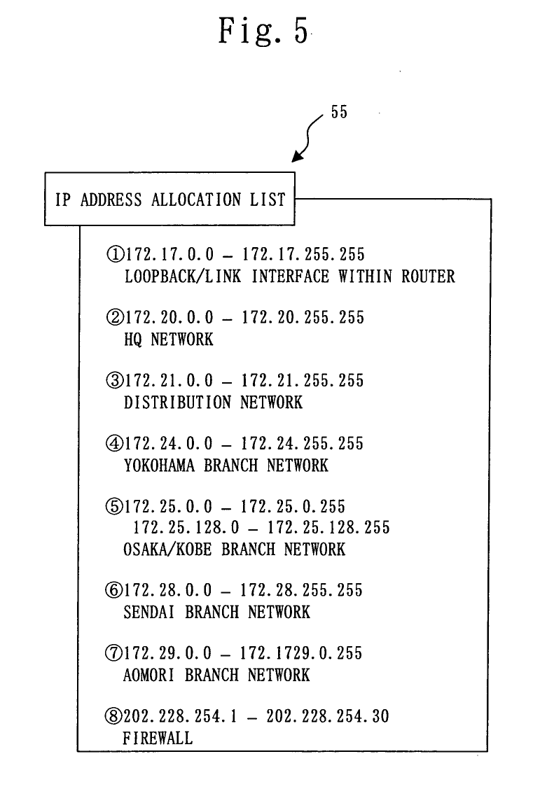

FIG. 5 shows a concrete example of the IP address allocation list 55.

FIGS. 4 and 5 correspond to the network addresses of the system diagram shown on FIG. 1. For example, the allocated network addresses for HQ as \mathring{2} in FIG. 5 corresponds to an area shown as \mathring{2} in FIG. 4. In FIG. 4, though an area for firewall shown as \mathring{8} in FIG. 5 is not shown on FIG. 4, it is possible to display the area for firewall by scrolling the screen to the right using the scroll bar 44.

An operation will be explained by referring to FIG. 3.

The display section 101 performs the operations of S1 through S4. Also, the allocation section 103 performs the operations of S5 through S13.

First, at S1, the display section 101 reads the IP address allocation information stored in the disk 91. At S2, the IP address information which has been read is displayed on the screen as the IP address allocation list 55. Then, at S3, according to the dividing position indicated, the display section 101 determines the horizontal axis 47 and the vertical axis 49 of the two-dimensional graph 53 to display.

Next, at S4, the display section 101 displays an area of the allocated network address in accordance with the IP address allocation information as an allocated area 43. At this point, the network manager can understand visually whether the network address is allocated or not.

The following description regards an operation of the allocation section 103 in use of the various buttons shown at the upper part of FIG. 2. When the END button 70 is selected, the allocation section 103 stores the latest information at S5 in a disk 91 as the allocated IP address information, and closes the display on the display screen 31.

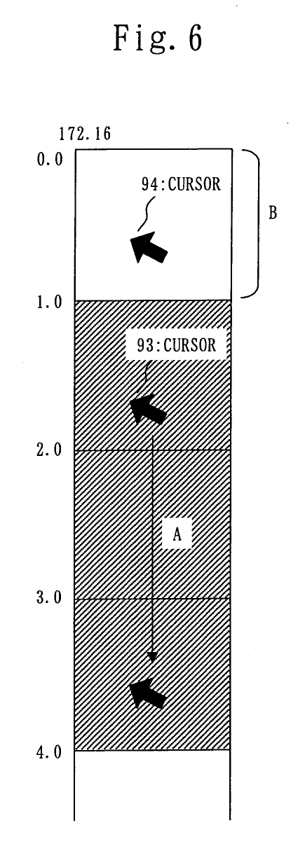

Also, when the NEW ALLOCATION button 71 is selected, the allocation section 103 proposes a network manager to select the unallocated area 41 at S6. For instance, this proposed selection can be performed as dragging a cursor 93 from some area to the another as an arrow A shown in FIG. 6.

Next, the allocation section 103 changes this selected area from the unallocated area 41 to the allocated area 43 to display at S7. In this way, the selected area is displayed as highlighting. In this case, such a new allocating operation is prohibited selecting the area which has been already allocated. If the network manager might click or drag the cursor 93 on the allocated area, an error message would be displayed.

Then, when the CHANGE ALLOCATION button 73 is selected, the allocation section 103 proposes the network manager to select the allocated area 43 displayed on the display screen 31 at S8. And at S9, a request to increase or decrease the area of the selected allocated area 43 is received, and the result of increment or decrement is displayed.

In case of changing the allocation, it is also prohibited selecting the area which has been already allocated as a new area for the changed.

Next, when the RELEASE ALLOCATION button 75 is selected, the allocation section 103 proposes a network manager to select the allocated area 43 at S10.

Then, at S11, the allocated area 43 which has been selected is changed to the unallocated area 41 and displayed as the unallocated area 41. In this case, it is also prohibited selecting the unallocated area 41.

Next, the ENLARGE button 77 or the REDUCE button 79 is selected, the allocation section 103 proposes a network manager to select the area at S12, and the size-changed area is displayed at S13.

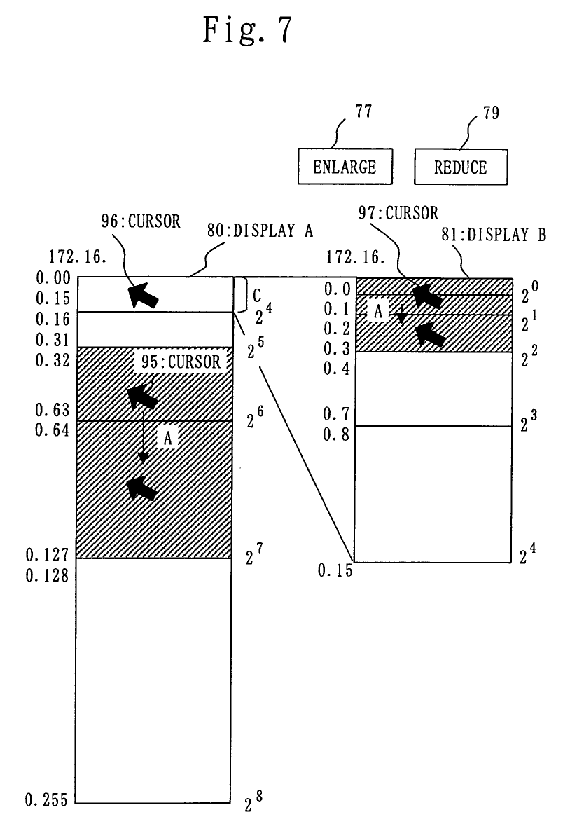

For example, the ENLARGE button 77 in FIG. 2 is selected, and a mouse is clicked at the position of the cursor 94 in FIG. 6, the left (display A 80) in FIG. 7 will be displayed. The left figure (display A 80) in FIG. 7 is an area B of FIG. 6 being enlarged and displayed. The case of selecting a part of area B can be performed in accordance with the same procedure for displaying the left figure (display A 80) on FIG. 7. FIG. 7 shows a case in which only a part of the area B is allocated in use of the cursor 95.

When the mouse is clicked at the position of cursor 96 after selecting the ENLARGE button 77 as shown on the display A 80 of FIG. 7, the area C of the display A 80 is further enlarged and displayed as shown on the display B 81 at the right in FIG. 7. Then, it enables to select only a part of the area C to be allocated.

The example, as shown in FIG. 7, is a case in which a part of 256 addresses is selected and allocated. To allocate the network addresses, the addresses must be divided at 2⁰, 2¹, 2², 2³, 2⁴, 2⁵, 2⁶, and 2⁷ as shown on FIG. 7, and be allocated per an unit of the divided area. For example, when cursor 95 is dragged as shown in FIG. 7, the allocation section 103 highlights a shaded part addressed from 172.16.0.32 through 172.16.0.63 and then another shaded part addressed from 172.16.0.64 through 172.16.0.127 is highlighted. Notably, during those sequential action, it is prohibited specifying the address.

Namely, the display A 80 of FIG. 7 shows a case in which the addresses 32 through 127 at the fourth byte are specified among the addresses 0 through 255, and it is prohibited specifying, for example, the address of 100 or 110 which is the intermediate address at the fourth byte. In this way, the address should be specified by automatically dividing the address per an unit of powered number of 2, therefore, it can be prevented that a network manager erroneously specify the intermediate address.

Similarly, the display B 81 of FIG. 7 shows a case in which the area addressed from the top through square of 2 (namely, four addresses) in use of cursor 97. In this case, it is also prohibited being divided at 5 and 6, which values are not the powered number of 2, among addresses 0 through 15 at the fourth byte.

Next, when the left divided position 61, the center divided position 63, or the right divided position 65 is selected, the operation returns to S3. At this point, the display section 101 activates to re-determine the horizontal axis 47 and the vertical axis 49, in use of the newly divided upper part of address 57 and the lower part of address 59, and displays a two-dimensional graph 53 on the display screen 31.

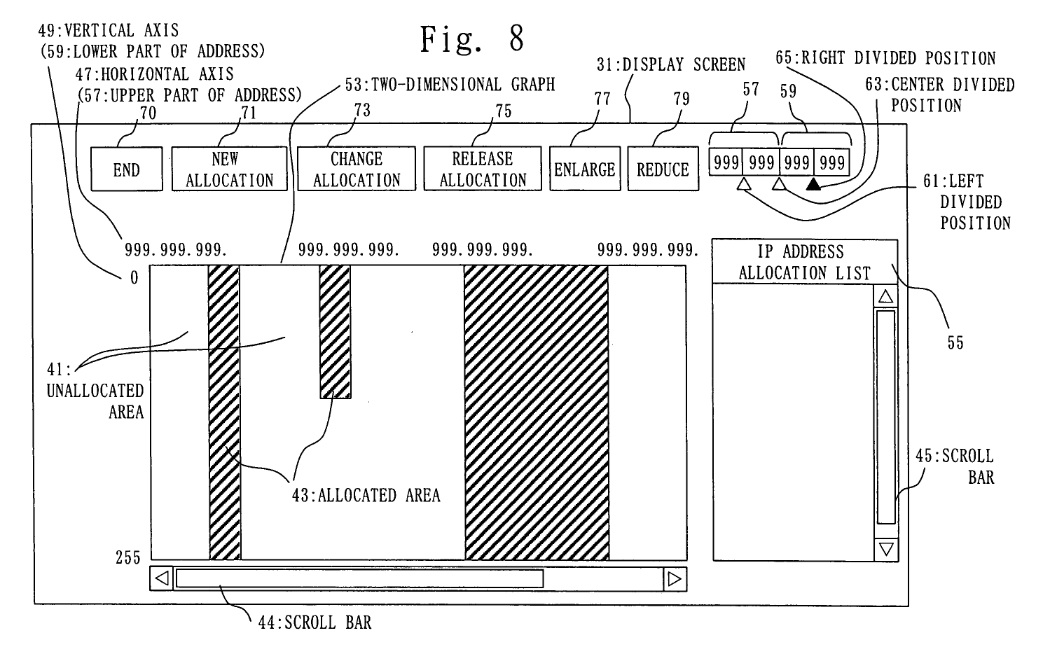

For example, FIG. 8 shows the display screen 31 when the right divided position 65 is selected. When the right divided position 65 is selected, the upper 3 bytes become the upper part of address 57 and used as the horizontal axis 47. Further, the lower 1 byte becomes the lower part of address 59 and is used as the vertical axis 49. In this way, changing of the dividing position enables to visually grasp the detailed and the overall information without the usage of ENLARGE button 77 or REDUCE button 79, and even the allocation of address can be performed.

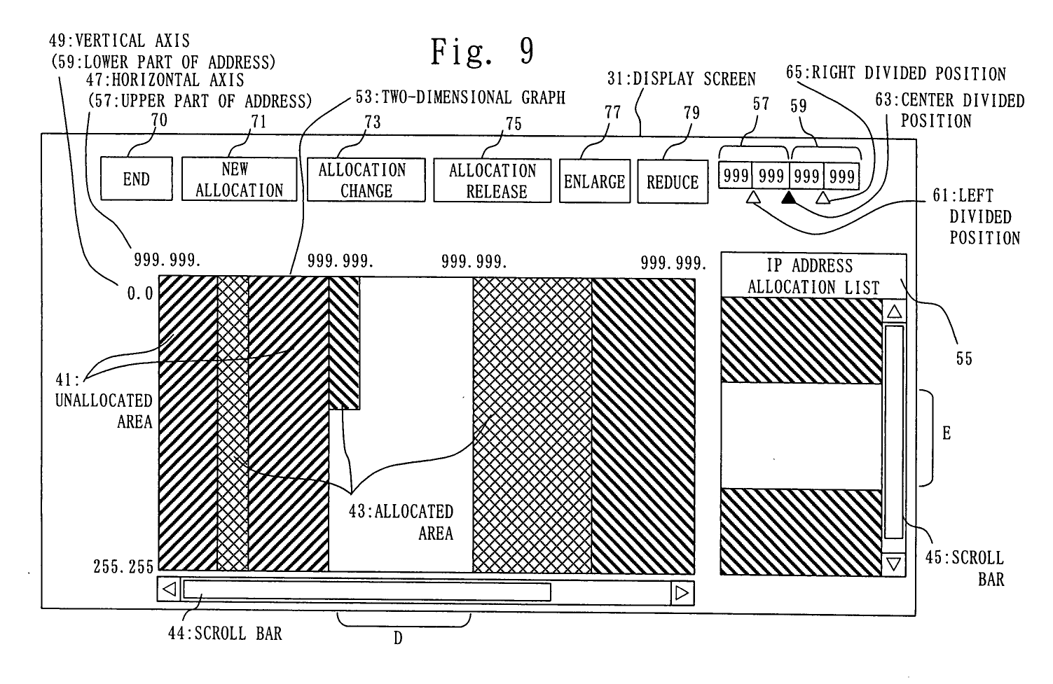

FIG. 9 shows a two-dimensional graph 53 in which only a part of the network addresses (zone D of the two-dimensional graph 53, namely address E of the IP address allocation list 55) is enabled to be allocatable, and the other part (except zone D, namely except addresses other than E) is enabled to be unallocatable, which is expressed as a zone with shaded or grayed. Since a network manager on a branch is required to allocate addresses only within one's branch system, as shown on FIG. 9, the allocation section 103 is required to allow to be allocatable, change or release only the area allocated to the branch. The display itself can be also restricted to view only the area allocated to the branch. Further, when there is a sub-branch under a branch, it enables a network manager of a sub-branch to be displayed only the area to be managed by the sub-branch, and to be allocatable. In this way, the two-dimensional graph 53 can be changed the display hierarchically according to the authority of a network manager. That is, the higher the position of a network manager is, the larger the managed area to be allocated. Therefore, an error which a network manager with a lower position specifies the upper network address as overlapping, can be prevented.

In the embodiment, the described case is to be displayed two-dimensionally using the IP address, however, the address can be applied in any form as long as the address consists of multiple bits or bytes. Also, the two-dimensional graph 53 shown on FIG. 2 is one of examples, and the horizontal axis and the vertical axis can be showed vice versa.

And the display of the allocated area 43 is one of examples, and the allocated area can be displayed in any way as long as the allocated area can be displayed distinctively from the unallocated area 41.

### INDUSTRIAL APPLICABILITY

As previously descried, the invention enables to identify allocated address and unallocated address clearly and easily by displaying the network address which is expressed as numeral values or numbers as two-dimensional graph visually.

Also, according to the invention, the allocation of a network address is performed by the operation of selecting the area shown two-dimensionally, which facilitates the allocation operation.

Further, according to the invention, a new allocation cannot be performed for the area which has been already allocated, which prevents from allocating error.

Further, according to the invention, the allocation of the area is restricted per the unit of powered number of 2, which enables to perform the allocation in accordance with a rule.

Further, according to the invention, the contents of display in the two-dimensional graph is changed in accordance with the authority of a network manager, which lends to increase the security performance.

Further, the allocation of a network address by a manager with lower position without an appropriate authority can be prevented.

1. A network address display device for dividing a network address into an upper part of address and a lower part of address, displaying a two-dimensional graph in use of the upper part of address and the lower part of address for each coordinate axis, and displaying an allocated network address area and an unallocated network address area distinctively on the two-dimensional graph.

2. A network address allocation device comprising:
a display section for dividing a network address into an upper part of address and a lower part of address, displaying a two-dimensional graph in use of the upper part of address and the lower part of address for each coordinate axis on a display screen, and displaying an allocated network address area and an unallocated network address area distinctively on the two-dimensional graph; and
an allocation section for allocating the network address by selecting the unallocated network address area displayed on the two-dimensional graph from the display screen and changing the unallocated network address area selected to an allocated network address area so as to display.

3. The network address allocation device of claim 2, wherein the allocation section, in case of allocating the network address, prohibits to select the allocated network address area again.

4. The network address allocation device of claim 2, wherein the allocation section divides 2⁸ numbers of the allocated network addresses per an area of 2⁰, 2¹, 2², 2³, 2⁴, 2⁵, 2⁶, and 2⁷, and selects each of divided areas as a unit for selection.

5. The network address allocation device of claim 2, wherein the display section displays, distinctively, an allocatable network address area allowed to be allocated by the allocation section and an unallocatable network address area not allowed to be allocated.
